(19) United States
(12) Patent Application Publication
(10) Pub. No.: US 2026/0299251 A1
(43) Pub. Date: Oct. 1, 2026

(54) Camera driving device and camera system

(71) Applicant: AAC Microtech (Changzhou) Co., Ltd., Changzhou City (CN)

(72) Inventors: Yun Tang, Changzhou (CN); Wei Song, Changzhou (CN)

(21) Appl. No.: 19/342,693

(22) Filed: Sep. 29, 2025

Related U.S. Application Data
(63) Continuation of application No. PCT/CN2025/086575, filed on Apr. 1, 2025.

(51) Int. Cl. G02B 7/09; G03B 13/36

(52) U.S. Cl. CPC G02B 7/09; G03B 13/36

(57) ABSTRACT

The embodiments of the present application provide a camera driving device and a camera system. The driving device includes a base, a magnet, a voice coil, and a lens barrel bracket movably mounted on the base. The magnet and the voice coil cooperate to drive the lens barrel bracket to move, the voice coil includes at least two spaced sub-voice coils, and the magnet includes multiple first sub-magnets and multiple second sub-magnets alternately arranged with the multiple first sub-magnets. In the camera driving device, at least two spaced sub-voice coils are set, and the first and the second sub-magnets are employed, which are alternately magnetized in radial and axial directions, ensuring a more uniform magnetic field distribution. Thereby, the motion accuracy and response speed of the lens barrel bracket are significantly improved, while providing greater driving force to support long-stroke driving and further reduce power consumption.

### CROSS-REFERENCE TO RELATED APPLICATIONS

This application is a continuation of International Application No. PCT/CN2025/086575, Apr. 1, 2025, the entire contents of which are incorporated herein by reference.

### TECHNICAL FIELD

The present application relates to the field of camera driving technologies, in particular to a camera driving device and a camera system.

### BACKGROUND

Conventional camera driving devices typically employ a single voice coil and magnet assembly to drive the lens barrel bracket for autofocus and optical image stabilization. However, due to issues such as non-uniform magnetic field distribution, slow response speed, and high-power consumption, they struggle to meet the requirements of high-quality photography.

Although existing improvement schemes, such as optimized magnet arrangements, have achieved some progress, they still suffer from issues like magnetic field interference and complex control mechanisms. Ensuring more uniform magnetic field distribution to significantly enhance the motion accuracy and response speed of the lens barrel bracket, while providing greater driving force for long-stroke actuation and further reducing power consumption, remains a critical challenge that needs to be addressed.

### SUMMARY

The embodiments of the present application are intended to address at least one of the technical problems existing in the related art, providing a camera driving device and a camera system.

On the one hand, the embodiments of the present application provide a camera driving device, including:
a base;
a magnet including a plurality of first sub-magnets and a plurality of second sub-magnets alternately arranged with the plurality of first sub-magnets;
a voice coil including at least two sub-voice coils spaced apart; and
a lens barrel bracket movably mounted on the base;
wherein one of the magnet and the voice coil is fixed to the base, and the other of the magnet and the voice coil is fixed to the lens barrel bracket, and the magnet and the voice coil cooperates to drive the lens barrel bracket to move; wherein the first sub-magnets are magnetized along a radial direction of the lens barrel bracket, and magnetization directions of two adjacent first sub-magnets are opposite; the second sub-magnets are magnetized along an axial direction of the lens barrel bracket, and magnetization directions of two adjacent second sub-magnets are opposite; and an end of each first sub-magnet facing the voice coil has the same polarity as an end of an adjacent second sub-magnet facing the first sub-magnet.

As an improvement, the first sub-magnets and the second sub-magnets are integrally formed.

As an improvement, the first sub-magnets and the second sub-magnets are sub-magnets arranged separately.

As an improvement, the lens barrel bracket comprises a first bottom wall and two first side walls that are spaced apart opposite to each other, both connected to the first bottom wall; the first bottom wall and the two first side walls form a first accommodation space for accommodating the lens barrel;
the base includes a second bottom wall and two second side walls that are spaced apart opposite to each other, both connected to the first bottom wall; the second bottom wall and the two second side walls form a second accommodation space for accommodating the lens barrel bracket; and
the first sub-magnets and the second sub-magnets are fixed on a side of the first side wall facing the second side wall, and the sub-voice coils are fixed on a side of the second side wall facing the first side wall.

As an improvement, the driving device further includes a rolling support member or a sliding support member disposed between the first bottom wall and the second bottom wall.

As an improvement, the driving device further includes a magnetic conductive member fixed to sides of the first sub-magnets and the second sub-magnets opposite to the voice coil.

As an improvement, the driving device further includes an elastic member, opposite ends of which are connected to the base and the lens barrel bracket, respectively.

As an improvement, the driving device further includes a housing enclosing the base and the lens barrel bracket, wherein the housing is open at both ends along the axial direction of the lens barrel bracket.

As an improvement, the driving device further includes a circuit board and a displacement sensor fixed to the base, wherein the sub-voice coils are electrically connected to the circuit board, and the circuit board is provided with a controller electrically connected to the displacement sensor;
the controller is configured to send electrical signals to each of the sub-voice coils individually according to a current position of the lens barrel bracket detected by the displacement sensor, so as to independently control each of the sub-voice coils to generate a magnetic field and cooperate with the first sub-magnets and the second sub-magnets to drive the lens barrel bracket to move along its axial direction until the lens barrel bracket reaches a target position.

On the other hand, an embodiment of the present application provides a camera system, including a camera module and the camera driving device described above.

In the camera driving device and camera system of the present application, at least two spaced sub-voice coils are set, and the first sub-magnets and the second sub-magnets are employed, which are alternately magnetized in radial and axial directions, ensuring a more uniform magnetic field distribution. Thereby, the motion accuracy and response speed of the lens barrel bracket are significantly improved, while providing greater driving force to support long-stroke driving and further reduce power consumption. This design not only enhances overall performance but is also suitable for high-end smartphones and professional cameras, meeting higher-demand photography requirements.

### BRIEF DESCRIPTION OF THE DRAWINGS

FIG. 1 is a schematic diagram of an overall structure of a camera driving device according to an embodiment of the present application.

FIG. 2 is a cross-sectional view taken along line A-A of FIG. 1.

FIG. 3 is a schematic diagram showing the arrangement between a voice coil, a magnet, and a magnetic conductive member in a conventional camera driving device.

FIG. 4 shows a force-displacement curve diagram of the conventional camera driving device.

FIG. 5 is a schematic diagram showing the arrangement between the voice coil, the magnet, and the magnetic conductive member in the camera driving device according to an embodiment of the present application.

FIG. 6 shows a force-displacement curve diagram of the camera driving device of the present application, along with a comparison diagram showing the force-displacement curves of the traditional camera driving device.

FIG. 7 is a three-dimensional exploded view of the camera driving device according to an embodiment of the present application.

### DETAILED DESCRIPTION OF THE EMBODIMENTS

To enable those skilled in the art to better understand the technical solutions of the present application, the present application will be further described in detail below with reference to the accompanying drawings and specific embodiments.

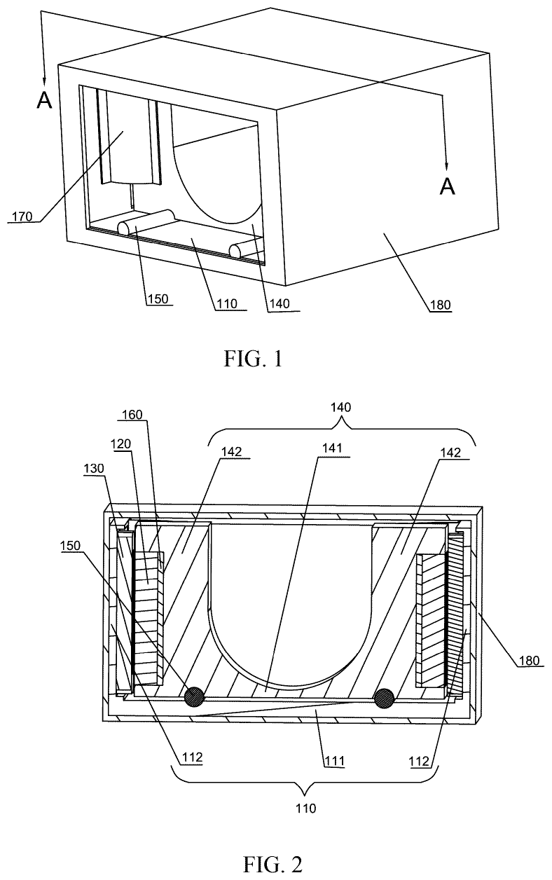

As shown in FIGS. 1 to 7, a camera driving device 100 includes a base 110, a magnet 120, a voice coil 130, and a lens barrel bracket 140 movably mounted on the base 110. One of the magnet 120 and the voice coil 130 is fixed to the base 110, the other of the magnet 120 and the voice coil 130 is fixed to the lens barrel bracket 140, and the magnet 120 and the voice coil 130 cooperate to drive the lens barrel bracket 140 to move.

The voice coil 130 includes at least two sub-voice coils 131 spaced apart from each other. The magnet 120 includes a plurality of first sub-magnets 121 and a plurality of second sub-magnets 122 alternately arranged with the multiple first sub-magnets 121. The first sub-magnets 121 are magnetized along a radial direction of the lens barrel bracket 140, and the magnetization directions of two adjacent first sub-magnets 121 are opposite. The second sub-magnets 122 are magnetized along an axial direction of the lens barrel bracket 140, and the magnetization directions of two adjacent second sub-magnets 122 are opposite. Furthermore, an end of each first sub-magnet 121 facing the voice coil 130 has the same polarity as an end of the adjacent second sub-magnet 122 facing the first sub-magnet 121.

Specifically, as shown in FIGS. 1 to 7, one of the magnet 120 and the voice coil 130 may be fixed to the lens barrel bracket 140, and the other is fixed to the base 110. Furthermore, the voice coil 130 is configured as at least two sub-voice coils 131 spaced apart, and the magnet 120 is configured as a plurality of first sub-magnets 121 and a plurality of second sub-magnets 122 alternately arranged with the plurality of first sub-magnets 121. It should be noted that the total number of first sub-magnets 121 and second sub-magnets 122 is at least five.

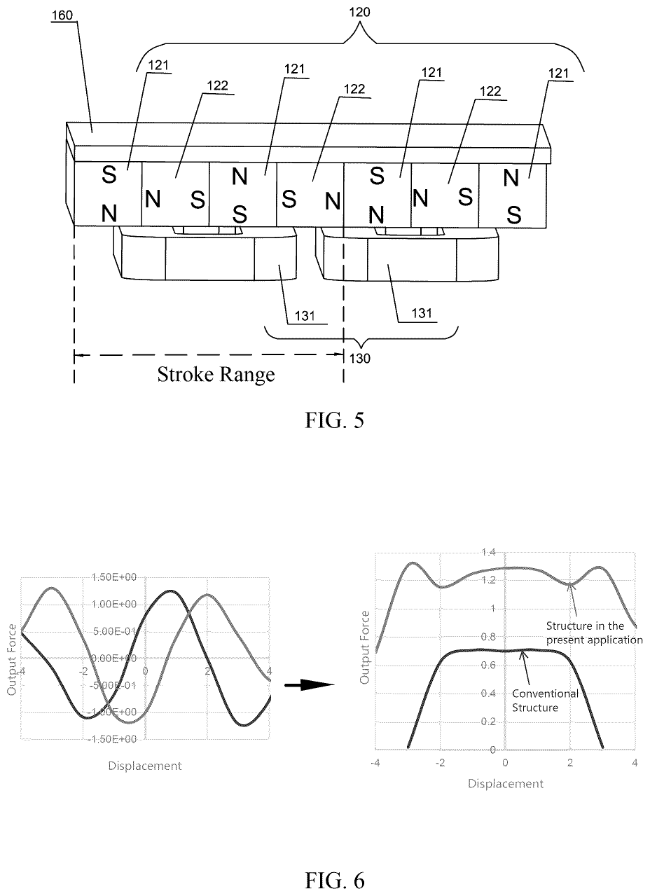

As a specific example, as shown in FIGS. 5 and 7, the number of the first sub-magnets 121 is four, and the number of the second sub-magnets 122 is three. The first sub-magnets 121 are magnetized along the radial direction of the lens barrel bracket 140, and the magnetization directions of two adjacent first sub-magnets 121 are opposite. The second sub-magnets 122 are magnetized along the axial direction of the lens barrel bracket 140, and the magnetization directions of two adjacent second sub-magnets 122 are opposite. The end of each first sub-magnet 121 facing the voice coil 130 has the same polarity as the end of the adjacent second sub-magnet 122 facing the first sub-magnet 121.

In the camera driving device and camera system of the embodiments of the present application, at least two spaced sub-voice coils are set, and the first sub-magnets and the second sub-magnets are employed, which are alternately magnetized in radial and axial directions, ensuring a more uniform magnetic field distribution. Thereby, the motion accuracy and response speed of the lens barrel bracket are significantly improved, while providing greater driving force to support long-stroke driving and further reduce power consumption. This design not only enhances overall performance but is also suitable for high-end smartphones and professional cameras, meeting higher-demand photography requirements.

In an embodiment, as shown in FIGS. 1 to 7, the first sub-magnets 121 and the second sub-magnet 122 are integrally formed. That is, the magnet 120 is an integrated magnet with different magnetization directions.

As shown in FIGS. 1 to 7, the first sub-magnet 121 and the second sub-magnet 122 are sub-magnets arranged separately. As shown in FIG. 5, the first sub-magnets 121 and the second sub-magnets 122 are both separately arranged sub-magnets, and they are magnetized using a Helmholtz array magnetization method. One sub-magnet is magnetized vertically, and the other sub-magnet is magnetized horizontally, arranged in sequence, and arranged in a 90° rotation pattern.

As shown in FIGS. 1 to 7, the lens barrel bracket 140 includes a first bottom wall 141 and two first side walls 142 that are spaced apart opposite to each other, both connected to the first bottom wall 41. The first bottom wall 141 and the two first side walls 142 form a first accommodation space 200 for accommodating the lens barrel (camera unit, not shown in the figures). The base 110 includes a second bottom wall 111 and two second side walls 112 that are spaced apart opposite to each other, both connected to the second bottom wall 111. The second bottom wall 111 and the two second side walls 112 form a second accommodation space 300 for accommodating the lens barrel bracket 140.

The first sub-magnets 121 and the second sub-magnets 122 are fixed on a side of the first side wall 142 facing the second side wall 112, and the sub-voice coils 131 are fixed on a side of the second side wall 112 facing the first side wall 142.

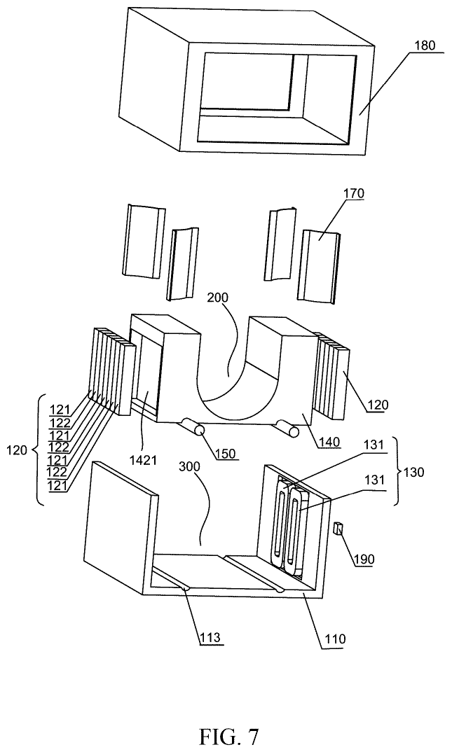

Specifically, as shown in FIGS. 1 to 7, the first sub-magnets 121, the second sub-magnets 122, and the sub-voice coils 131 are respectively fixed on opposite sides of the first side wall 142 and the second side wall 112. When the sub-voice coils 131 are energized to generate a magnetic field, it works in conjunction with the first sub-magnets 121 and the second sub-magnets 122 to drive the lens barrel bracket 140 to move along its axial direction. As shown in FIGS. 5 and 6, the left-side view of FIG. 6 shows the individual force-displacement curve of the two sub-voice coils 131 when the configuration includes two sub-voice coils 131, four first sub-magnets 121, and three second sub-magnets 122. The force-displacement curve on the right side of FIG. 6 represents the total output performance of the camera driving device of the present application, obtained by summing the absolute values of the output forces from the two sub-voice coils 131 in the left-side view.

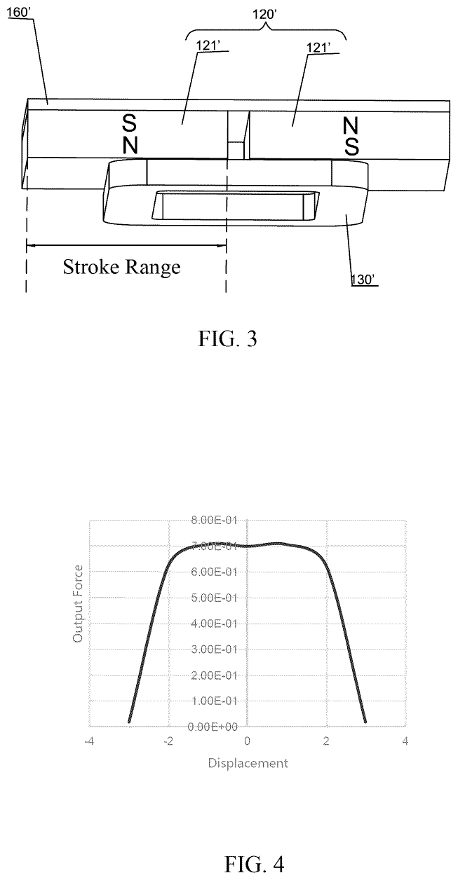

As shown in FIGS. 3 and 4, FIG. 3 is a schematic diagram showing the arrangement between the voice coil 130′, the magnet 120′, and the magnetic conductive member 160′ in a traditional camera driving device. In the traditional camera driving device, a single voice coil 130′ is used, and the magnet 120′ is divided into two separate sub-magnets 121′. The magnetic conductive member 160′ is disposed on a side of the magnet 120′ away from the voice coil 130′. Both the sub-magnets 121′ are magnetized along the radial direction of the lens barrel bracket, with opposite magnetization directions. The traditional structure is used to drive the lens barrel bracket. The force-displacement curve of the conventional structure in the right-side view of FIG. 6 is identical to that in FIG. 4, both representing the output performance of a traditional camera driving device achieved by using the structure shown in FIG. 3

It should be noted that the output force and displacement curves in FIGS. 4 and 6 are obtained under the condition that the magnetic circuit volumes of the traditional camera driving device and the camera driving device of the present application are the same. Clearly, by referring to FIGS. 3 to 6 together, under the same magnetic circuit volume, the output force and displacement of the camera driving device 100 of the present application are superior to those of the traditional camera driving device. In other words, the camera driving device 100 of the present application ensures a more uniform magnetic field distribution, thereby significantly improving the motion accuracy and response speed of the lens barrel bracket, while providing greater driving force to support long-stroke motion. The camera driving device of the present application has greater driving force and a larger stroke range compared to the traditional camera driving device.

Both FIG. 4 and FIG. 6 present force-displacement curves obtained under the condition that the conventional camera driving device and the camera driving device in the present application have identical magnetic circuit volumes. Evidently, as shown in FIGS. 3 to 6, the camera driving device 100 in the present application demonstrates superior output force and displacement compared to the conventional device at equivalent magnetic circuit volumes. That is, the camera driving device 100 in the present application ensures more uniform magnetic field distribution, thereby significantly improving motion accuracy and response speed of the lens barrel bracket while providing greater driving force for long-stroke movement. Relative to the conventional device, the camera driving device in the present application achieves enhanced driving force and extended stroke range.

As shown in FIGS. 1 to 7, the driving device 100 further includes a circuit board and a displacement sensor 190 fixed to the base 110. The sub-voice coils 131 are electrically connected to the circuit board, and the circuit board is equipped with a controller electrically connected to the displacement sensor 190.

The controller is configured to send electrical signals to each sub-voice coil 131 individually according to a current position of the lens barrel bracket 140 detected by the displacement sensor 190, to independently control each of the sub-voice coils 131 to generate a magnetic field and cooperate with the first sub-magnets 121 and the second sub-magnets 122 to drive the lens barrel bracket 140 to move along its axial direction until the lens barrel bracket 140 reaches a target position.

Specifically, as shown in FIGS. 2 and 7, the displacement sensor 190 may be provided on a side of the second side wall 112 facing the first side wall 142, and may further be located within a coil-enclosed region formed by any one of the sub-voice coils 131.

The displacement sensor 190 is configured to detect the current position of the lens barrel bracket 140 and transmit this position to the controller. When the circuit board is powered, the controller sends electrical signals to each sub-voice coil 131 individually according to the detected current position, thereby independently controlling each sub-voice coil 131 to generate a magnetic field and cooperate with the first sub-magnets 121 and the second sub-magnets 122 to drive the lens barrel bracket 140 to move along its axial direction until the lens barrel bracket 140 reaches the target position and stops. In an embodiment, separate driving amplifiers may also be provided between the controller and each sub-voice coil 131. The electrical signals emitted by the controller are first amplified by the corresponding driving amplifiers and then transmitted to the respective sub-voice coils 131.

As shown in FIGS. 1 to 7, the driving device 100 further includes a rolling support member 150 or a sliding support member 150 disposed between the first bottom wall 141 and the second bottom wall 111.

As a specific example, as shown in FIGS. 1, 2, and 7, an accommodating groove is provided on the second bottom wall 111, which is configured to accommodate the sliding support member 150, enabling the lens barrel bracket 140 to slide relative to the base 110. Exemplarily, the sliding support member 150 may be configured as a sliding shaft. In an embodiment, the accommodating groove 113 may also accommodate the rolling support member to facilitate rolling movement of the lens barrel bracket 140 relative to the base 110, and the rolling support members may be configured as balls.

As shown in FIGS. 2 and 5, the driving device 100 further includes a magnetic conductive member 160 fixed to the sides of the first sub-magnets 121 and the second sub-magnets 122 opposite to the voice coil 130. The magnetic conductive member effectively reduces magnetic field interference, thereby enhancing the performance and reliability of the driving device.

Furthermore, as shown in FIGS. 2 and 7, a snap-fit slot 1421 is provided on a side of the first side wall 142 facing the second side wall 112. The snap-fit slot 1421 is configured to accommodate and fix the magnetic conductive member 160, the first sub-magnets 121, and the second sub-magnets 122.

As shown in FIGS. 1, 2, and 7, the driving device 100 further includes an elastic member 170, opposite ends of which are connected to the base 110 and the lens barrel bracket 140, respectively. The elastic member 170 provides additional restoring force to the lens barrel bracket 140 during its movement. The elastic member 170 may be made of a polymer film.

Furthermore, the driving device 100 further includes a housing 180 enclosing the base 110 and the lens barrel bracket 140, which is open at both ends along the axial direction of the lens barrel bracket 140. The housing 180 protects the internal components while also facilitating the movement of the lens barrel bracket 140.

On the other hand, the present application further provides a camera system, including a camera module and the camera driving device 100 described above. The specific structure of the camera driving device 100 may be referred to in the relevant descriptions above, and will not be described in detail here.

In the camera driving device and camera system of the present application, at least two

spaced sub-voice coils are set, and the first sub-magnets and the second sub-magnets are employed, which are alternately magnetized in radial and axial directions, ensuring a more uniform magnetic field distribution. Thereby, the motion accuracy and response speed of the lens barrel bracket are significantly improved, while providing greater driving force to support long-stroke driving and further reduce power consumption. This design not only enhances overall performance but is also suitable for high-end smartphones and professional cameras, meeting higher-demand photography requirements.

It should be understood that the above embodiments are merely illustrative examples used to explain the principles of the present application, but the present application is not limited thereto. For those skilled in the art, various modifications and improvements may be made without departing from the spirit and scope of the present application, and such modifications and improvements are also considered within the scope of the present application.

What is claimed is:

1. A camera driving device, comprising:
a base;
a magnet comprising a plurality of first sub-magnets and a plurality of second sub-magnets alternately arranged with the plurality of first sub-magnets;
a voice coil comprising at least two sub-voice coils spaced apart; and
a lens barrel bracket movably mounted on the base;
wherein one of the magnet and the voice coil is fixed to the base, and the other of the magnet and the voice coil is fixed to the lens barrel bracket, and the magnet and the voice coil cooperates to drive the lens barrel bracket to move; wherein the first sub-magnets are magnetized along a radial direction of the lens barrel bracket, and magnetization directions of two adjacent first sub-magnets are opposite; the second sub-magnets are magnetized along an axial direction of the lens barrel bracket, and magnetization directions of two adjacent second sub-magnets are opposite; and an end of each first sub-magnet facing the voice coil has the same polarity as an end of an adjacent second sub-magnet facing the first sub-magnet.

2. The camera driving device of claim 1, wherein the first sub-magnets and the second sub-magnets are integrally formed.

3. The camera driving device of claim 1, wherein the first sub-magnets and the second sub-magnets are sub-magnets arranged separately.

4. The camera driving device of claim 1, wherein the lens barrel bracket comprises a first bottom wall and two first side walls that are spaced apart opposite to each other, both connected to the first bottom wall; the first bottom wall and the two first side walls form a first accommodation space for accommodating the lens barrel;
the base comprises a second bottom wall and two second side walls that are spaced apart opposite to each other, both connected to the first bottom wall; the second bottom wall and the two second side walls form a second accommodation space for accommodating the lens barrel bracket; and
the first sub-magnets and the second sub-magnets are fixed on a side of the first side wall facing the second side wall, and the sub-voice coils are fixed on a side of the second side wall facing the first side wall.

5. The camera driving device of claim 4, further comprising a rolling support member or a sliding support member disposed between the first bottom wall and the second bottom wall.

6. The camera driving device of claim 4, further comprising a magnetic conductive member fixed to sides of the first sub-magnets and the second sub-magnets opposite to the voice coil.

7. The camera driving device of claim 1, further comprising an elastic member, opposite ends of which are connected to the base and the lens barrel bracket, respectively.

8. The camera driving device of claim 1, further comprising a housing enclosing the base and the lens barrel bracket, wherein the housing is open at both ends along the axial direction of the lens barrel bracket.

9. The camera driving device of claim 1, further comprising a circuit board and a displacement sensor fixed to the base, wherein the sub-voice coils are electrically connected to the circuit board, and the circuit board is provided with a controller electrically connected to the displacement sensor;
the controller is configured to send electrical signals to each of the sub-voice coils individually according to a current position of the lens barrel bracket detected by the displacement sensor, so as to independently control each of the sub-voice coils to generate a magnetic field and cooperate with the first sub-magnets and the second sub-magnets to drive the lens barrel bracket to move along its axial direction until the lens barrel bracket reaches a target position.

10. A camera system, comprising: a camera module and a camera driving device of claim 1.
